(19) United States
(12) Patent Application Publication
(10) Pub. No.: US 2009/0127352 A1
(43) Pub. Date: May 21, 2009

(54) Apparatus for airbrush waste removal

(76) Inventor: Daryl P. Hinther, Jordan, MT (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/232,093

(22) Filed: Sep. 10, 2008

Related U.S. Application Data
(60) Provisional application No. 60/996,434, filed on Nov. 16, 2007.

(51) Int. Cl. B08B 15/02; B08B 3/04

(52) U.S. Cl. 239/112; 134/104.4; 15/301; 55/385.4

(57) ABSTRACT

The apparatus for airbrush waste removal has an airtight canister with an inlet port having a tip suction nozzle into which the airbrush nozzle is inserted. The canister has a discharge port connected to a source of suction, which may be a vacuum pump, a venturi, or the like. A discharge conduit leads from the suction source to outside air, and may include a charcoal filter, catalytic converter, burn chamber, or other device for reducing volatile organic compounds from the air discharged from the canister. A vapor permeable filter is disposed in the discharge conduit to prevent solid and/or liquid particles from entering the suction source.

### CROSS-REFERENCE TO RELATED APPLICATION

This application claims the benefit of U.S. Provisional Patent Application Ser. No. 60/996,434, filed Nov. 16, 2007.

### FIELD OF THE INVENTION

The present invention relates to devices for cleaning paint sprayers and other painting apparatus, and particularly to an apparatus for airbrush waste removal that provides effective cleaning of an airbrush nozzle while protecting the user from exposure to noxious fumes from cleaning solvents.

### DESCRIPTION OF THE RELATED ART

An airbrush, spray gun or similar tool relies on compressed air to deliver particles from a source through an airbrush nozzle and tip, thereby forcibly separating the particles into a fine mist in a process known as atomization. An advantage of atomization is that the particles can be distributed consistently and precisely so that the process can be used for intricate detailing. Furthermore, an airbrush can dispense from a source in such a manner that few, if any, recharges are required. When used for painting, an airbrush generally uses less paint than a standard bristled brush by eliminating paint lost through absorption by bristles or as a result of over painting.

In order to maintain the integrity of an airbrush and its work product, it is recommended that the airbrush be cleaned, i.e., that all particles in the airbrush be completely removed before and/or after each use. The most common way to remove particles is by completely flushing the airbrush with a cleaning solution or solvent, such as acetone or mineral spirits. A general method is to fill the source that feeds into the airbrush with a solvent, and then to activate the source of compressed air, transporting the residual particles out the nozzle as atomized waste. It is common practice to direct the waste into a trashcan, a towel, or the ambient environment.

Artists in fields such as taxidermy and nail technology typically use an airbrush and work in closed spaces. As a result, these artists, their clients and guests are continuously exposed to atomized waste and subject to inhaling the residual gas, noxious fumes, and other vapors lingering in the air. It is well known that prolonged inhalation and exposure to this atomized waste may be toxic and may lead to serious and severe medical effects, including tachycardia, liver disease and death. Thus, an apparatus for the removal of airbrush waste solving the aforementioned problem is desired.

### SUMMARY OF THE INVENTION

The apparatus for airbrush waste removal has an airtight canister with an inlet port having a tip suction nozzle into which the airbrush nozzle is inserted. The canister has a discharge port connected to a source of suction, which may be a vacuum pump, a venturi nozzle, or the like. A discharge conduit leads from the suction source to outside air, and may include a charcoal filter, catalytic converter, burn chamber, or other device for reducing volatile organic compounds from the air discharged from the canister. A vapor permeable filter is disposed in the discharge conduit to prevent solid and/or liquid particles from entering the suction source.

When cleaning an airbrush, a cleaning solvent, such as acetone or lacquer thinner, is placed in the airbrush reservoir or paint cup, the airbrush nozzle is inserted into the tip suction nozzle, and compressed air is run through the airbrush barrel and nozzle while applying suction to the discharge port. Solid and/or liquid particles are trapped within the canister and settle to the bottom. Fumes that carry volatile organic compounds that may be noxious or toxic are removed from the canister by suction and discharged to outside air, and may optionally be filtered to remove or break down the volatile organic compounds before discharge to outside air, particularly when required to comply with clean air or other environmental regulations. The canister may also have an additional inlet port for cleaning paint cups.

These and other features of the present invention will become readily apparent upon further review of the following specification and drawings.

### BRIEF DESCRIPTION OF THE DRAWINGS

FIG. 1 is a block diagram of an apparatus for airbrush waste removal according to the present invention.

FIG. 2 is a perspective view of a canister in an apparatus for airbrush waste removal according to the present invention, shown broken away and partially in section to show details of the canister.

FIG. 3 is an enlarged perspective view of the tip suction nozzle portion of the canister shown in FIG. 2.

FIG. 4 is a perspective view of a first embodiment of an apparatus for airbrush waste removal according to the present invention, having a vacuum pump as the source of suction.

FIG. 5 is a perspective view of a second embodiment of an apparatus for airbrush waste removal according to the present invention, having a venturi nozzle as the source of suction.

Similar reference characters denote corresponding features consistently throughout the attached drawings.

### DETAILED DESCRIPTION OF THE PREFERRED EMBODIMENTS

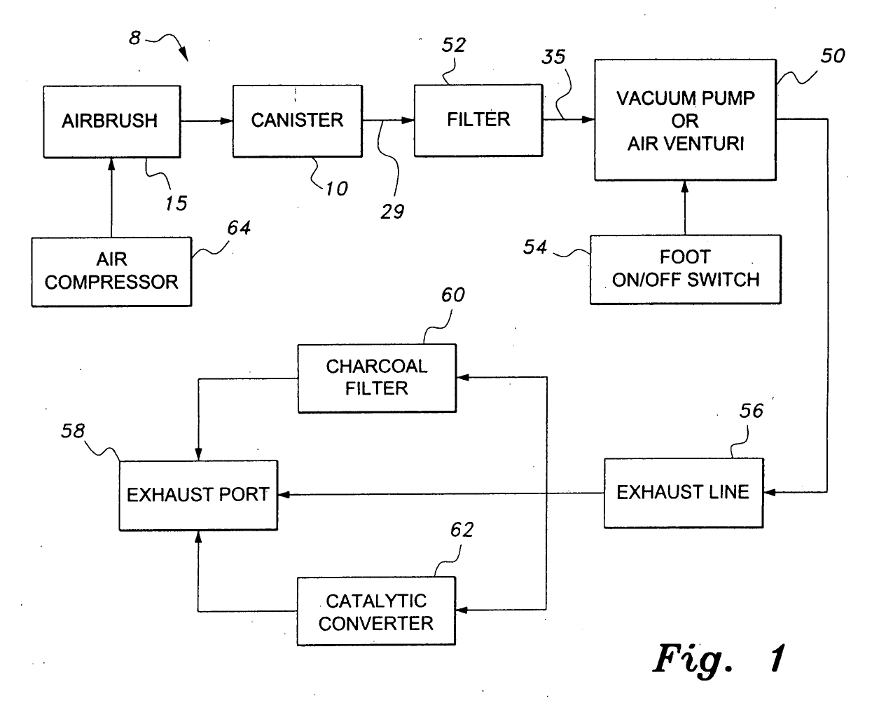

The apparatus for airbrush waste removal supports conventional airbrushes, spray guns and other paint tools that emit a spray of atomized particles, and provides for a safe and effective way to keep harmful toxins away from a user when cleaning the tool. FIG. 1 shows a block diagram of the airbrush waste removal apparatus, designated generally as 8 in the drawings. The apparatus for airbrush waste removal 8 includes a source of suction 50, which may be a vacuum pump, a venturi nozzle, or the like, connected to the discharge conduit 29. A foot-operated switch 54 or pedal may be used to control the application of suction to the canister 10. An inline filter 52 is disposed between the canister 10 and the source of suction 50 to prevent clogging the vacuum pump or venturi nozzle. An exhaust conduit 56 leads from the source of suction 50 to an exhaust port 58 that discharge fumes from the airbrush to outside air. The apparatus 8 may either discharge the fumes directly to ambient air, or may optionally include either a charcoal filter 60 or a catalytic converter 62 or burn chamber disposed in the exhaust conduit between the source of suction 50 and the exhaust port 58 when required to comply with clean air or other environmental regulations relating to the discharge of volatile organic compounds to the atmosphere. The airbrush 15 is preferably connected to an air compressor 64 to simultaneously pump air through the airbrush barrel and nozzle while the source of suction 50 exhausts volatile matter from the canister 10.

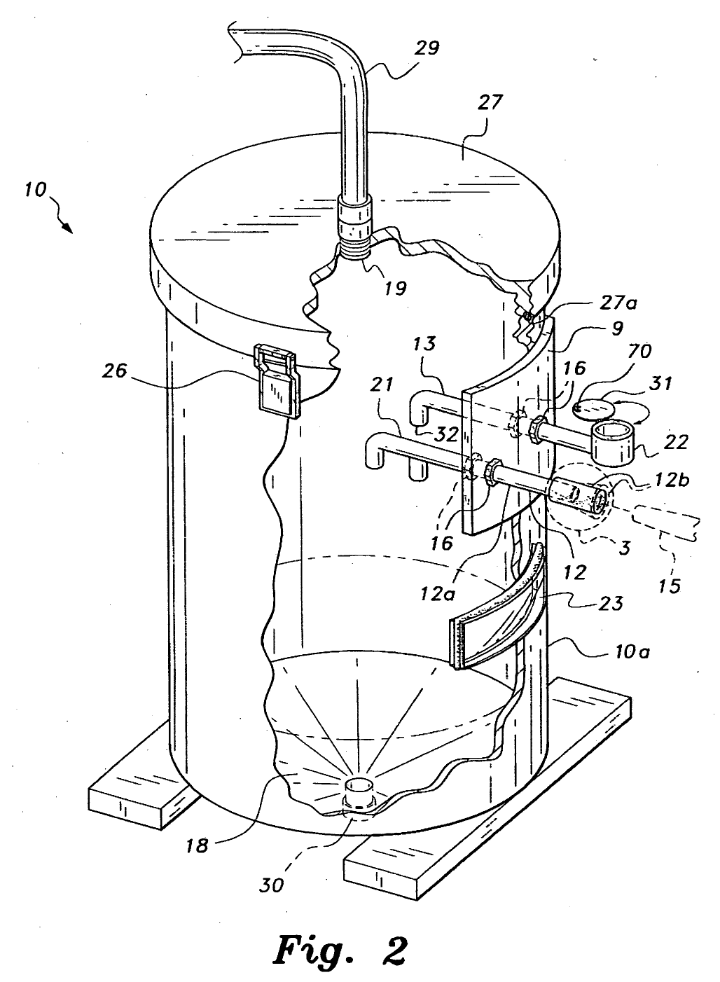

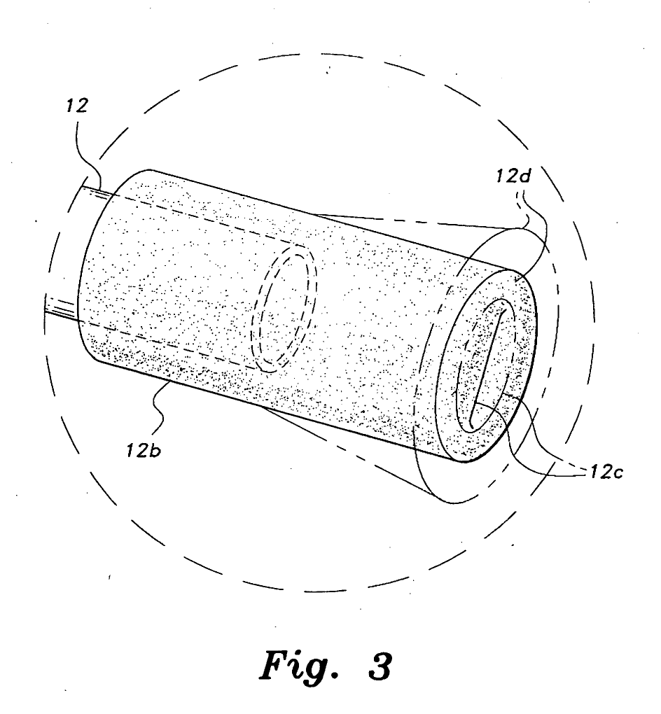

The structure of canister 10 is best shown in FIGS. 2 and 3. Airbrush 15 is directed to an inlet port of canister 10 when flushing. To do so, the tip of airbrush 15 is inserted into a tip suction nozzle 12. The tip suction nozzle 12 has a cylindrical stem 12a and a flexible, resilient port 12b attached to the cylindrical stem. As shown in FIG. 3, the port 12b is generally tubular when relaxed, but expands to a generally conical shape conforming to the shape of the conical tip of the airbrush 15 when the airbrush nozzle is inserted into the port 12b. The port 12b has a membrane 12d across the opening of the port 12b with a slit 12c defined therein to permit insertion of the airbrush nozzle, the membrane 12d forming a resilient seal around the airbrush 15 to prevent fumes from escaping and to maintain negative pressure in the canister 10. The cylindrical stem 12a of tip suction nozzle 12 is threaded to mate with internal threads defined in a bore extending through plate 9, which is attached to the exterior of the canister wall 10a. The cylindrical stem 12a also has a hex nut 16 threaded thereon that abuts the plate 9, serving as a stop so that nozzle 12 is not threaded too far into plate 9.

Inside the canister 10 is an inlet pipe 21, which is threaded at one end to mate with internal threads defined in a bore in alignment with stem 12a to form a continuous inlet port. A hex nut 16 is also threaded onto pipe 21 to abut the peripheral canister wall 10a, serving as a stop to prevent threading pipe 21 too far through the peripheral canister wall 10a. Pipe 21 has an inside diameter of about ¼″, and has a right angle bend directed towards the bottom 18 of the canister 10 to direct solids and liquids downward, while allowing fumes and vapors to rise toward the top of the canister.

The bottom 18 of canister 10 is provided with a drain plug or valve 30 that may be selectively removed or opened to release accumulated solids and liquids. The canister 10 has a removable lid 27, and a chemically resistant nitrile O-ring 27a disposed between the lid 27 and the top of the canister wall 10a to provide an airtight seal. A discharge port 19 is defined through the lid 27, leading to a discharge conduit 29. The lid 27 is secured to canister 10 by clips 26.

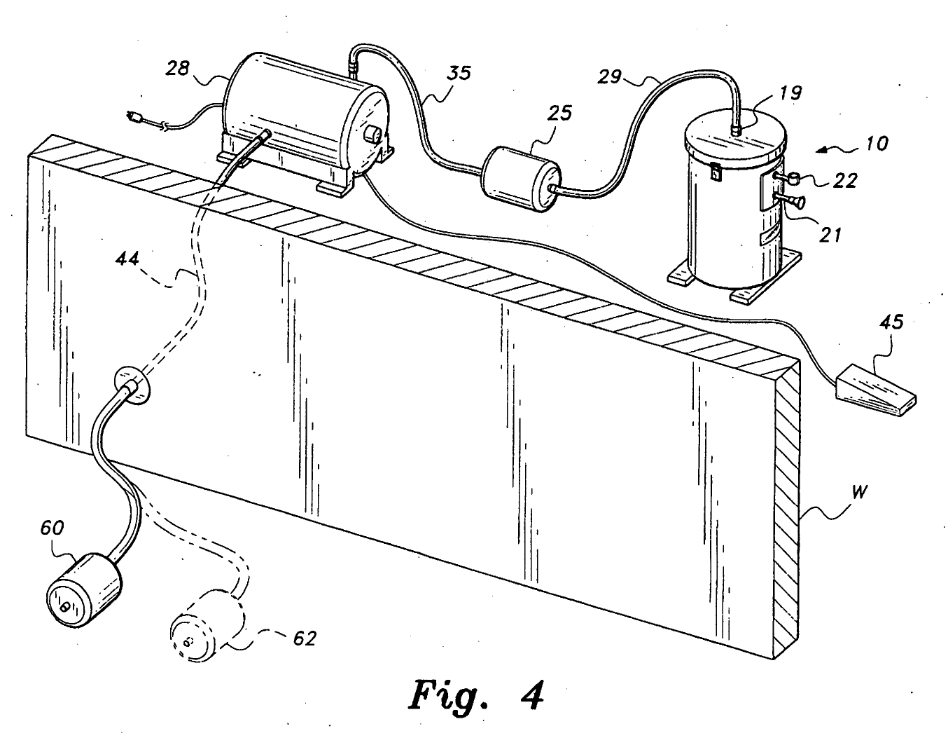

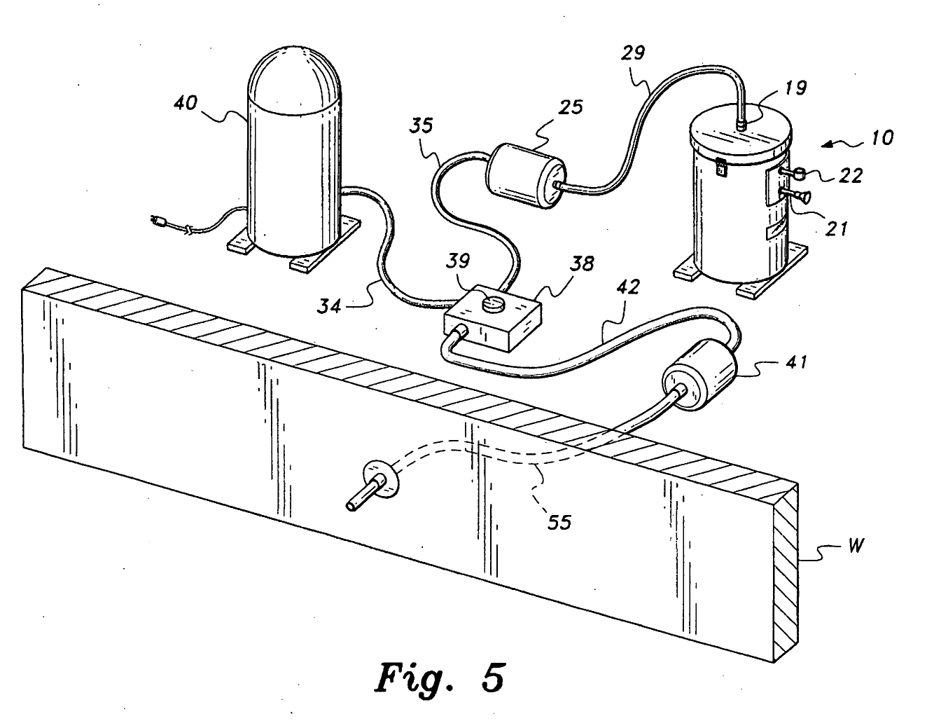

The canister is provided with a sight glass 23 disposed in a rubber seal in the canister wall 10a so that the level of accumulated liquids and solids may be observed. An auxiliary intake port that includes a reservoir 22 accepts waste directly into canister 10. Reservoir 22 can be positioned laterally of tip suction nozzle 12, as shown in FIG. 2, or arranged vertically, as shown in FIGS. 4 and 5. When using an attached can as the source for airbrush paint, the contents of the paint can are agitated with solvent and then directly poured into reservoir 22 during cleaning. When not in use, reservoir 22 is closed or covered by lid 31. Lid 31 can be opened with minimal effort by manipulation of a flange 70, and includes a spring-biased mechanism that forces lid 31 closed when not held open, ensuring airflow integrity and waste removal from reservoir 22. Waste received through reservoir 22 is drawn into canister 10 via pipe 13. Pipe 13 has an internal diameter of about ⅜ in., and is provided with a 90° elbow to direct the waste downward.

FIG. 4 shows an embodiment of the apparatus in which the source of suction comprises a vacuum pump 28. An inline filter 25 is connected to discharge conduit 29, and a vacuum hose 35 both applies a vacuum to canister 10 and withdraws fumes through the vacuum pump 28, for discharge through hose 44 through outside wall W. A foot-operated pedal 45 controls application of vacuum by pump 28. A charcoal filter 60 or a catalytic converter 62 filters fumes, exhausted to outside air.

FIG. 5 shows another embodiment of the apparatus in which the source of suction comprises a venturi 41. Compressor 40 through hose 34 to regulator or valve 38 supplies compressed air. Venturi 41 is connected to valve 38 by hose 42. Canister 10 is connected to valve 38 by discharge conduit 29 through inline filter 25 and hose 35. A foot switch 39 is activated to open the valve 38 to apply air through venturi 41, creating suction applied through valve 38 to canister 10, thereby withdrawing fumes from canister 10 through valve 38 and venturi 41 to exhaust conduit 55, which exhausts the fumes through an exhaust port in outside wall W directly to outside air. Filter 25 may be a charcoal based filter. Conduits or hoses 29 and 35 are approximately ¼ in. tubing, which can be fabricated from rubber, polyvinyl chloride, or any other non-corrosive, flexible material.

It is to be understood that the present invention is not limited to the embodiments described above, but encompasses any and all embodiments within the scope of the following claims.

I claim:

1. An apparatus for airbrush waste removal, comprising:
a canister having a primary inlet port adapted for connecting an airbrush thereto and having a primary outlet port; and
means for applying suction to the canister through the outlet port in order to withdraw volatile airbrush cleaning solvent fumes from the canister.

2. The apparatus for airbrush waste removal according to claim 1, wherein said means for applying suction comprises a vacuum pump connected to the primary outlet port.

3. The apparatus for airbrush waste removal according to claim 1, wherein said means for applying suction comprises a venturi connected to the primary outlet port.

4. The apparatus for airbrush waste removal according to claim 1, wherein said primary inlet port comprises:
a tubular stem external to the container;
a flexible, resilient tube extending from the stem;
a membrane extending across an end of the tube, the membrane having a slit defined therein for receiving a tip of the airbrush; and
an inlet pipe inside said canister, the inlet pipe and the tubular stem forming a fluid conduit, the inlet pipe having a bend formed therein adapted for directing airbrush wastes drawn towards a bottom of the canister.

5. The apparatus for airbrush waste removal according to claim 1, further comprising a sight glass disposed in said canister for viewing contents of said canister.

6. The apparatus for airbrush waste removal according to claim 1, wherein said canister further comprises an auxiliary input port having a reservoir for receiving paint waste, the reservoir having a lid.

7. The apparatus for airbrush waste removal according to claim 1, further comprising an exhaust tube extending from said means for applying suction, the exhaust tube venting volatile waste to the atmosphere.

8. The apparatus for airbrush waste removal according to claim 7, further comprising means disposed in said exhaust tube for processing volatile wastes harmful to the environment prior to discharging the volatile waste to the atmosphere.

9. The apparatus for airbrush waste removal according to claim 8, wherein said processing means is selected from the group consisting of a charcoal filter, a catalytic converter, and a burn chamber.

10. The apparatus for airbrush waste removal according to claim 1, wherein said means for applying suction further comprises a foot-operated pedal switch turning the means for applying suction on and off.

11. An apparatus for airbrush waste removal, comprising:
a canister having a primary inlet port adapted for connecting an airbrush thereto and having a primary outlet port; and
a vacuum pump connected to the primary outlet port for applying suction to the canister through the outlet port in order to withdraw volatile airbrush cleaning solvent fumes from the canister.

12. The apparatus for airbrush waste removal according to claim 11, wherein said primary inlet port comprises:
a tubular stem external to the container;
a flexible, resilient tube extending from the stem;
a membrane extending across an end of the tube, the membrane having a slit defined therein for receiving a tip of the airbrush; and
an inlet pipe inside said canister, the inlet pipe and the tubular stem forming a fluid conduit, the inlet pipe having a bend formed therein adapted for directing airbrush wastes drawn towards a bottom of the canister.

13. The apparatus for airbrush waste removal according to claim 11, further comprising an exhaust tube extending from said vacuum pump, the exhaust tube venting volatile waste to the atmosphere.

14. The apparatus for airbrush waste removal according to claim 13, further comprising means disposed in said exhaust tube for processing volatile wastes harmful to the environment prior to discharging the volatile waste to the atmosphere.

15. The apparatus for airbrush waste removal according to claim 14, wherein said processing means is selected from the group consisting of a charcoal filter, a catalytic converter, and a burn chamber.

16. An apparatus for airbrush waste removal, comprising:
a canister having a primary inlet port adapted for connecting an airbrush thereto and having a primary outlet port; and
a venturi connected to the primary outlet port for applying suction to the canister through the outlet port in order to withdraw volatile airbrush cleaning solvent fumes from the canister.

17. The apparatus for airbrush waste removal according to claim 1 6, wherein said primary inlet port comprises:
a tubular stem external to the container;
a flexible, resilient tube extending from the stem;
a membrane extending across an end of the tube, the membrane having a slit defined therein for receiving a tip of the airbrush; and
an inlet pipe inside said canister, the inlet pipe and the tubular stem forming a fluid conduit, the inlet pipe having a bend formed therein adapted for directing airbrush wastes drawn towards a bottom of the canister.

18. The apparatus for airbrush waste removal according to claim 16, further comprising an exhaust tube extending from said means for applying suction, the exhaust tube venting volatile waste to the atmosphere.

19. The apparatus for airbrush waste removal according to claim 18, further comprising means disposed in said exhaust tube for processing volatile wastes harmful to the environment prior to discharging the volatile waste to the atmosphere.

20. The apparatus for airbrush waste removal according to claim 19, wherein said processing means is selected from the group consisting of a charcoal filter, a catalytic converter, and a burn chamber.
